(19) United States
(12) Patent Application Publication
(10) Pub. No.: US 2023/0014315 A1
(43) Pub. Date: Jan. 19, 2023

(54) TRAINED MODEL ESTABLISHMENT METHOD, ESTIMATION METHOD, PERFORMANCE AGENT RECOMMENDATION METHOD, PERFORMANCE AGENT ADJUSTMENT METHOD, TRAINED MODEL ESTABLISHMENT SYSTEM, ESTIMATION SYSTEM, TRAINED MODEL ESTABLISHMENT PROGRAM, AND ESTIMATION PROGRAM

(71) Applicant: Yamaha Corporation, Hamamatsu (JP)

(72) Inventors: Akira MAEZAWA, Hamamatsu (JP); Katsumi ISHIKAWA, Hamamatsu (JP)

(21) Appl. No.: 17/952,077

(22) Filed: Sep. 23, 2022

Related U.S. Application Data
(63) Continuation of application No. PCT/JP2021/009362, filed on Mar. 9, 2021.

(30) Foreign Application Priority Data
Mar. 24, 2020 (JP) 2020-052757

(51) Int. Cl. G10H 1/00; G06N 20/00

(52) U.S. Cl. CPC G10H 1/0008; G06N 20/00; G10H 2210/091; G10H 2220/455

(57) ABSTRACT

A trained model establishment method realized by a computer includes acquiring a plurality of datasets each of which is formed by a combination of first performance data of a first performance by a performer, second performance data of a second performance performed together with the first performance, and a satisfaction label indicating a degree of satisfaction of the performer, and executing machine learning of a satisfaction estimation model by using the plurality of datasets. In the machine learning, the satisfaction estimation model is trained such that, for each of the datasets, a result of estimating a degree of satisfaction the performer from the first performance data and the second performance data matches the degree of the satisfaction indicated by the satisfaction label.

### CROSS-REFERENCE TO RELATED APPLICATIONS

This application is a continuation application of International Application No. PCT/JP2021/009362, filed on Mar. 9, 2021, which claims priority to Japanese Patent Application No. 2020-052757 filed in Japan on Mar. 24, 2020. The entire disclosures of International Application No. PCT/JP2021/009362 and Japanese Patent Application No. 2020-052757 are hereby incorporated herein by reference.

### BACKGROUND

### Technological Field

This disclosure relates to a trained model establishment method, an estimation method, a performance agent recommendation method, a performance agent adjustment method, a trained model establishment system, an estimation system, a trained model establishment program, and an estimation program.

### Background Information

Various performance evaluation methods for evaluating performances performed by performers have been developed and are known from the prior art. For example, Japanese Patent No. 3678135 proposes a technology for evaluating performance operations by selectively targeting part of the entire musical piece that is played.

### SUMMARY

The technology proposed in Japanese Patent No. 3678135 makes it possible to evaluate the accuracy of a performer's performance. However, the present inventors have found that the conventional technology has the following problem. That is, in general, a performer often plays together (collaborative performance) with other performers (for example, other people, performance agents, etc.). In a collaborative performance, a first performance by a performer and a second performance by another performer are performed in parallel. This second performance performed by another performer is usually not the same as the first performance. Thus, it is difficult to estimate the performer's degree of satisfaction with the collaborative performance or the collaborating performer from the accuracy of the performance.

This disclosure is made in light of the above-mentioned circumstances, and an object of one aspect of this disclosure is to provide a technology for appropriately estimating the degree of satisfaction of the performer of the first performance with respect to the second performance performed together with the first performance by the performer, a technology for recommending a performance agent that uses such a technology, and a technique for adjusting the performance agent.

In order to achieve the object described above, a trained model establishment method realized by at least one computer according to one aspect of this disclosure comprises acquiring a plurality of datasets each of which is formed by a combination of first performance data of a first performance by a performer, second performance data of a second performance performed together with the first performance, and a satisfaction label configured to indicate a degree of satisfaction of the performer, and executing machine learning of a satisfaction estimation model by using the plurality of datasets. The machine learning is configured by training the satisfaction estimation model such that, for each of the datasets, a result of estimating the degree of satisfaction of the performer from the first performance data and the second performance data matches the degree of satisfaction indicated by the satisfaction label.

Further, an estimation method realized by at least one computer according to one aspect of this disclosure includes acquiring first performance data of a first performance by a performer and second performance data of a second performance performed together with the first performance, estimating a degree of satisfaction of the performer from the first performance data and the second performance data that have been acquired, by using a trained satisfaction estimation model generated by machine learning, and outputting information pertaining to a result of estimating the degree of satisfaction.

Further, a performance agent recommendation method realized by at least one computer according to one aspect of this disclosure includes supplying first performer data pertaining to the first performance to each of a plurality of performance agents that include the performance agent, and generating, at the plurality of performance agents, a plurality of pieces of second performance data for a plurality of second performances that includes the second performance, estimating the degree of satisfaction of the performer with respect to each of the plurality of performance agents, by using a trained satisfaction estimation model, according to the estimation method, and selecting, based on the degree of satisfaction estimated for each of the plurality of performance agents, one performance agent to be recommended from among the plurality of performance agents.

Further, a performance agent adjustment method realized by at least one computer according to one aspect of this disclosure includes supplying first performer data pertaining to the first performance to the performance agent and generating the second performance data of the second performance at the performance agent, estimating the degree of satisfaction of the performer with respect to the performance agent, by using the satisfaction estimation model, according to the estimation method, and modifying an internal parameter value of the performance agent that is used to generate the second performance data. The generating, the estimating, and the modifying are iteratively executed to adjust the internal parameter value so as to raise the degree of satisfaction.

### BRIEF DESCRIPTION OF THE DRAWINGS

FIG. 1 shows one example of the configuration of an information processing system according to a first embodiment.

FIG. 2 shows an example of the hardware configuration of a performance control device according to the first embodiment.

FIG. 3 shows an example of the hardware configuration of an estimation device according to the first embodiment.

FIG. 4 shows an example of the software configuration of an information processing system according to the first embodiment.

FIG. 5 is a flowchart showing an example of the training process of a satisfaction estimation model according to the first embodiment.

FIG. 6 is a flowchart showing an example of the estimation process according to the first embodiment.

FIG. 7 is a sequence diagram showing an example of the recommendation process according to a second embodiment.

FIG. 8 is a sequence diagram showing an example of the adjustment process according to a third embodiment.

### DETAILED DESCRIPTION OF THE EMBODIMENTS

Embodiments of this disclosure will be described in detail below with reference to the appended drawings. The embodiments described below are merely examples of configurations that can realize this disclosure. Each of the embodiments described below can be appropriately refined or modified in accordance with various conditions and the configuration of the device to which this disclosure is applied. Further, not all combinations of the elements included in the following embodiments are essential for realizing this disclosure, and some of the elements can be omitted as deemed appropriate. Therefore, the scope of this disclosure is not limited by the configurations described in the following embodiments. Further, as long as they are not mutually contradictory, configurations combining a plurality of configurations described in the embodiments can also be employed.

### 1. First Embodiment

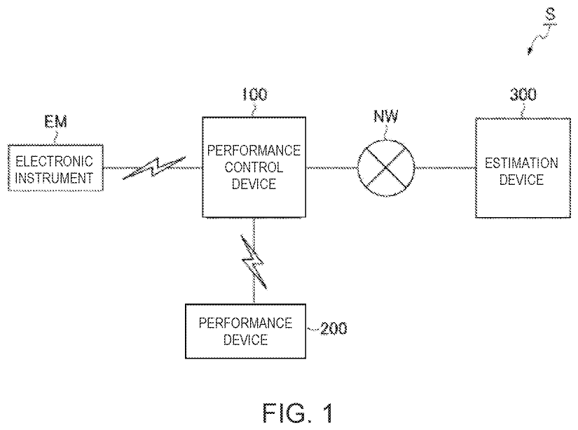

FIG. 1 shows an example of the configuration of an information processing system S according to a first embodiment. As shown in FIG. 1, the information processing system S of the first embodiment includes a performance control device 100 and an estimation device 300. The information processing system S according to the first embodiment is one example of a trained model establishment system. Further, the information processing system S according to the first embodiment is also an example of an estimation system. The performance control device 100 and the estimation device 300 can be realized by an information processing device (computer), such as a personal computer, a server, a tablet terminal, or a mobile terminal (such as a smartphone). The performance control device 100 and the estimation device 300 can be configured to be capable of directly communicating via a network NW.

The performance control device 100 according to the first embodiment is a computer configured to include a performance agent 160 that controls a performance device 200, such as a player piano, to play a musical piece. The performance device 200 can be appropriately configured to perform a second performance in accordance with second performance data representing the second performance. The estimation device 300 according to the first embodiment is a computer configured to generate a trained satisfaction estimation model by machine learning. Further, the estimation device 300 is a computer configured to use a trained satisfaction estimation model to estimate the degree of satisfaction (favorability) of the performer with respect to the collaborative performance between the performer and the performance agent 160. The process for generating the trained satisfaction estimation model and the process for estimating the performer's degree of satisfaction using the trained satisfaction estimation model can be executed by the same computer or by separate computers. The “degree of satisfaction” as used in this disclosure means the degree of personal satisfaction of a particular performer.

The performer in this embodiment typically performs using an electronic instrument EM connected to the performance control device 100. The electronic instrument EM of this embodiment can be an electronic keyboard instrument (electronic piano, etc.), an electronic string instrument (electric guitar, etc.), an electronic wind instrument (wind synthesizer, etc.). However, the musical instrument that the performer uses for performance is not limited to the electronic instrument EM. In another example, the performer can perform using an acoustic instrument. In yet another example, the performer according to the embodiment can be a singer of a musical piece who does not use a musical instrument. In this case, the performer's performance can be performed without using a musical instrument. Hereinbelow, the performer's performance is referred to as the “first performance” and the performance by an actor that is not the performer that carries out the first performance (the performance agent 160, another person, etc.) is referred to as the “second performance.”

In general, in a training stage, the information processing system S according to the first embodiment acquires a plurality of datasets, each formed by a combination of first performance data of a first performance for training by a performer, second performance data of a second performance for training, which is performed together with the first performance, and a satisfaction label configured to indicate the degree of satisfaction (true value/correct answer) of the performer, and by using the acquired plurality of datasets, executes machine learning of a satisfaction estimation model. The machine learning of the satisfaction estimation model is configured by training the satisfaction estimation model, so that for each of the datasets, a result of estimating the performer's degree of satisfaction from the first performance data and the second performance data matches the degree of satisfaction (true value/correct answer) indicated by the satisfaction label.

Further, in the estimation stage, the information processing system S according to the first embodiment acquires first performance data of a first performance by a performer and second performance data of a second performance performed together with the first performance, estimates the performer's degree of satisfaction from the first performance data and the second performance data that have been acquired, by using the trained satisfaction estimation model generated by machine learning, and outputs information related to a result of estimating the degree of satisfaction. Estimating the performer's degree of satisfaction from the first performance data and the second performance data can be include calculating a collaborative performance feature amount based on the first performance data and the second performance data, and estimating the performer's degree of satisfaction from the calculated collaborative performance feature amount.

### 2. Hardware Configuration Examples

### (Performance Control Device)

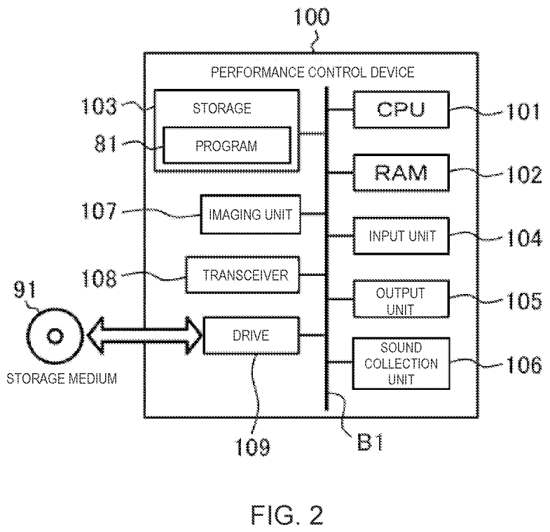

FIG. 2 shows one example of the hardware configuration of the performance control device 100 according to the embodiment. As shown in FIG. 2, the performance control device 100 is a computer in which a CPU (Central Processing Unit) 101, a RAM (Random Access Memory) 102, a storage 103, an input unit 104, an output unit 105, a sound collection unit 106, an imaging unit 107, a transceiver 108, and a drive 109 are electrically connected via a bus B1.

The CPU 101 includes one or a plurality of processors for executing various computations in the performance control device 100. The CPU 101 is one example of a processor resource. The type of the processor can be selected as deemed appropriate in accordance with the implementation. The performance control device 100 can be configured to comprise, instead of the CPU 101 or in addition to the CPU 101, an SPU (Sound Processing Unit), a DSP (Digital Signal Processor), an FPGA (Field Programmable Gate Array), an ASIC (Application Specific Integrated Circuit), etc. The RAM 102 is a volatile storage medium that operates as a working memory in which various types of information, such as the setting values used by the CPU 101, are stored, and into which various programs are loaded. The storage 103 is a non-volatile storage medium in which various programs and data used by the CPU 101 arm stored. The RAM 102 and the storage 103 are examples of memory resources (computer memories) that hold programs that are executed by the processor resource.

In the embodiment, various types of information such as a program 81 are stored in the storage 103. The program 81 is a program for causing the performance control device 100 to execute information processing for generating the second performance data representing the second performance that is performed in parallel with the first performance of the musical piece by the performer, as well as information processing for adjusting an internal parameter value of the performance agent 160. The program 81 includes a series of instructions for the information processing.

The input unit 104 includes an input device (user operable input) for receiving operations for the performance control device 100. The input unit 104 can, for example, include one or a plurality of input devices, such as a keyboard, a mouse, and the like, which are connected to the performance control device 100.

The output unit 105 includes an output device for outputting various types of information. The output unit 105 can include one or a plurality of output devices, such as a display, a speaker, and the like, for example, which are connected to the performance control device 100. The information can be output in the form of video signals, audio signals, or the like, for example.

The input unit 104 and the output unit 105 can be integrally configured by an input/output device, such as a touch panel display that receives user operations on the performance control device 100, and outputs various types of information.

The sound collection unit 106 is configured to convert the collected sound into electronic signals and to supply the electronic signals to the CPU 101. The sound collection unit 106 includes a microphone, for example. The sound collection unit 106 can be built into the performance control device 100 or connected to the performance control device 100 via an interface, not shown.

The imaging unit 107 is configured to convert captured images into electronic signals and to supply the electronic signals to the CPU 101. The imaging unit 107 includes a digital camera, for example. The imaging unit 107 can be built into the performance control device 100 or connected to the performance control device 100 via an interface, not shown.

The transceiver 108 is configured to transmit to and receive data from other devices, by wire or wirelessly. In the embodiment, the performance control device 100 can be connected via the transceiver 108 to the performance device 200 to be controlled, the electronic instrument EM that the performer uses to play the musical piece, and the estimation device 300, to transmit and receive data. The transceiver 108 also can include a plurality of modules (for example, a Bluetooth (registered trademark) module, a Wi-Fi (registered trademark) module, a USB (Universal Serial Bus) port, a dedicated port, etc.).

The drive 109 is a drive device for reading various types of information, such as programs stored in the storage medium 91. The storage medium 91 accumulates information, such as programs, by electronic, magnetic, optical, mechanical, or chemical means, so that a computer and other devices and machines can read the various stored information, such as programs. The storage medium 91 can be, for example, a floppy disk, an optical disc (for example, a compact disk, a digital versatile disk, a Blu-ray disk), a magnetooptical disk, a magnetic tape, a non-volatile memory card (for example, a flash memory), or the like. The type of drive 109 can be arbitrarily selected in accordance with the type of storage medium 91. The program 81 can be stored in the storage medium 91, and the performance control device 100 can read the above-described program 81 from the storage medium 91.

The bus B1 is a signal transmission path that electrically interconnects the above-mentioned hardware components of the performance control device 100. With respect to the specific hardware configuration of the performance control device 100, components can be omitted, replaced, or supplemented as deemed appropriate in accordance with the implementation. For example, at least one or more of the input unit 104, the output unit 105, the sound collection unit 106, the imaging unit 107, the transceiver 108, or the drive 109 can be omitted.

### (Estimation Device)

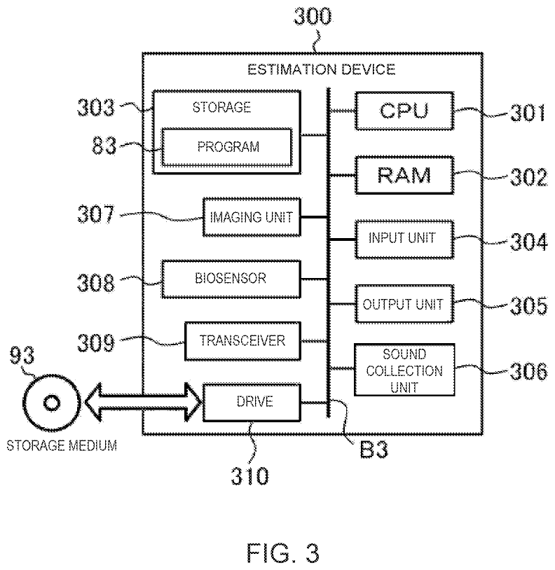

FIG. 3 shows an example of the hardware configuration of the estimation device 300 according to the embodiment. As shown in FIG. 3, the estimation device 300 is a computer in which a CPU 301, a RAM 302, a storage 303, an input unit 304, an output unit 305, a sound collection unit 306, an imaging unit 307, a biosensor 308, a transceiver 309, and a drive 310 are electrically connected via a bus B3.

The CPU 301 includes one or a plurality of processors for executing various computations in the estimation device 300. The CPU 301 is one example of a processor resource. The type of processor can be selected as deemed appropriate in accordance with the implementation. The estimation device 300 can be configured to comprise, instead of the CPU 301 or in addition to the CPU 301, an SPU (Sound Processing Unit), a DSP (Digital Signal Processor), an FPGA (Field Programmable Gate Array), an ASIC (Application Specific Integrated Circuit), etc. The RAM 302 is a volatile storage medium that operates as a working memory in which various types of information, such as the setting values used by the CPU 301, are stored, and in which various programs are loaded. The storage 303 is a non-volatile storage medium that stores various programs and data used by the CPU 301. The RAM 302 and the storage 303 are examples of memory resources (computer memories) that hold programs that are executed by the processor resource.

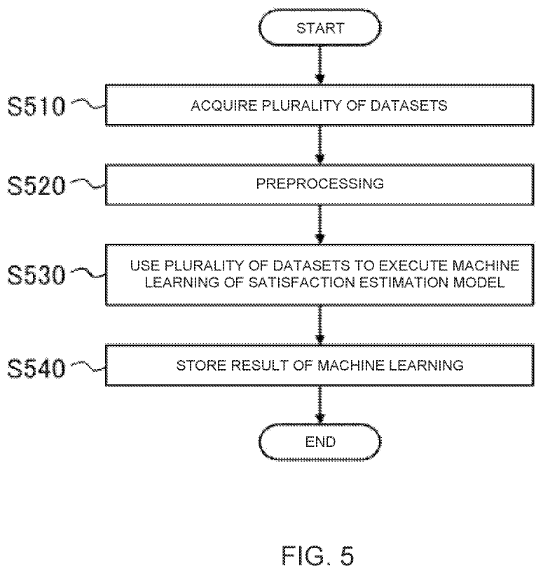

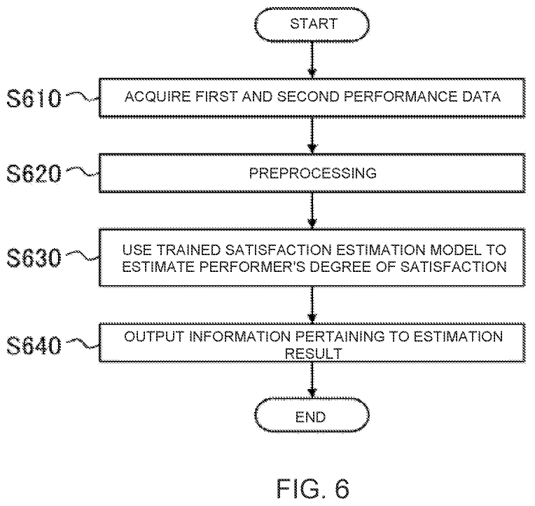

In the embodiment, the storage 303 stores various types of information such as a program 83. The program 83 causes the estimation device 300 to execute information processing (FIG. 5, described further below) for training a degree of satisfaction estimation model, and information processing (FIG. 6, described further below) to estimate the degree of satisfaction using the trained satisfaction estimation model. The instruction portion of the program 83 that implements machine learning of the satisfaction estimation model is an example of a trained model establishment program. Further, the instruction portion of the program 83 that estimates the degree of satisfaction is an example of an estimation program. The establishment program and the estimation program can be contained in the same file or stored in separate files.

The input unit 304, the imaging unit 307, the drive 310, and the storage medium 93 can be respectively configured in the same manner as the input unit 104, the imaging unit 107, the drive 109, and the storage medium 91 of the performance control device 100. The program 83 can be stored in the storage medium 93, and the estimation device 300 can read the program 83 from the storage medium 93.

The biosensor 308 is configured to acquire a time series of biological signals indicating biological information of the performer. The biological information of the performer can be formed by one or a plurality of types of data, such as heart rate, perspiration volume, blood pressure, etc. The biosensor 308 can include one or more sensors, such as a pulse monitor, perspiration monitor, blood pressure monitor, etc.

The transceiver 309 is configured to send and receive data to and from other devices, by wire or wirelessly. In the embodiment, the estimation device 300 can, via the transceiver 309, be connected to the performance control device 100 and the electronic instrument EM used when the performer plays the musical piece, to thereby send and receive data. Like the transceiver 108, the transceiver 309 can include a plurality of modules.

The bus B3 is a signal transmission path that electrically interconnects the hardware components of the estimation device 300. With respect to the specific hardware configuration of the estimation device 300, components can be omitted, replaced, or supplemented as deemed appropriate in accordance with the implementation. For example, at least one or more of the input unit 304, the output unit 305, the sound collection unit 306, the imaging unit 307, the biosensor 308, the transceiver 309, or the drive 310 can be omitted.

### 3. Software Configuration Examples

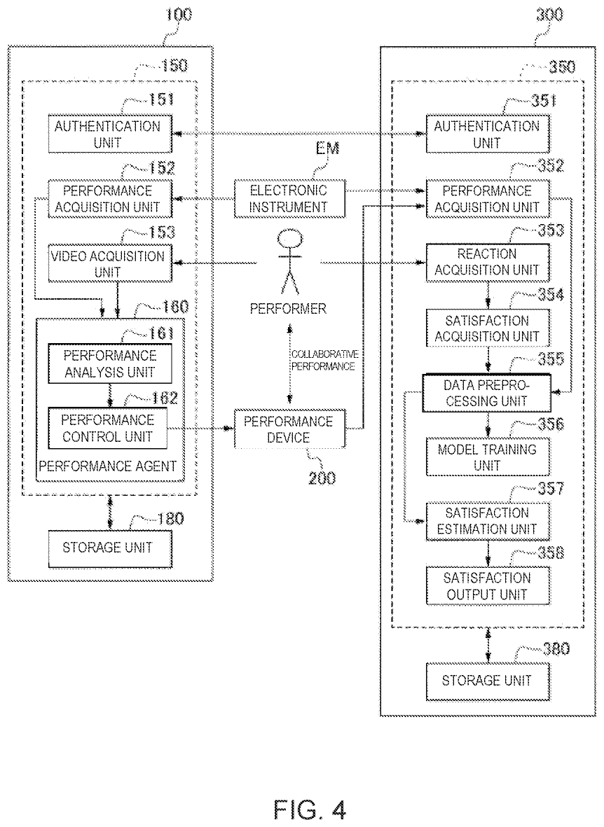

FIG. 4 shows one example of a software configuration of the information processing system S according to the embodiment.

The performance control device 100 has a control unit 150 and a storage unit 180. The control unit 150 is configured to integrally control the operation of the performance control device 100 by the CPU 101 and the RAM 102. The storage unit 180 is configured to store various data used in the control unit 150, by the RAM 102 and the storage 103. The CPU 101 of the performance control device 100 loads the program 81 stored in the storage 103 in the RAM 102 and executes the instructions contained in the program 81 and loaded in the RAM 102. The performance control device 100 (control unit 150) thus operates as a computer that includes an authentication unit 151, a performance acquisition unit 152, a video acquisition unit 153, and the performance agent 160 as software modules.

The authentication unit 151 is configured to cooperate with an external device, such as the estimation device 300 to authenticate the user (performer). In one example, the authentication unit 151 is configured to transmit, to the estimation device 300, authentication data such as a password and a user identifier input by the user using the input unit 104, and to permit or deny the user's access based on the authentication result received from the estimation device 300. The external device that authenticates the user can be an authentication server other than the estimation device 300. The authentication unit 151 can be configured to supply the user identifier of the authenticated (access-granted) user to another software module.

The first performer data pertains to the first performance of the performer, and can be configured to include at least one or more of the performance sound, the first performance data, or an image for the first performance by the performer. Of the foregoing, the performance acquisition unit 152 is configured to acquire the first performer data related to the sound of the first performance by the performer. In one example, the performance acquisition unit 152 can acquire as the first performer data the performance sound data indicated by electronic output signals from the sound collection unit 106 that collects the sound of the first performance. The performance acquisition unit 152 can also acquire as the first performer data the first performance data (for example, time-stamped MIDI data sequences) indicating the first performance supplied from the electronic instrument EM. The first performer data can be formed by information indicating the characteristics (for example, sound generation time and pitch) of the sounds included in the performance and can be a type of high-dimensional time-series data which represent the first performance by the performer. The performance acquisition unit 152 is configured to supply the first performer data regarding the acquired sound to the performance agent 160. The performance acquisition unit 152 can be configured to transmit the first performer data regarding the acquired sound to the estimation device 300.

The video acquisition unit 153 is configured to acquire the first performer data regarding video of the first performance by the performer. The video acquisition unit 153 is configured to acquire as the first performer data the video data representing a video of the performer that carries out the first performance. In one example, the video acquisition unit 153 can acquire as the first performer data the video data based on electronic signals representing images of the performer in the first performance captured by the imaging unit 107. Alternatively, the video data can be formed by motion data representing characteristics of the movements of the performer in the performance and can be a type of high-dimensional time-series data which represent the performance by the performer. Motion data are, for example, times series data of the overall image or the skeleton of the performer. The images included in the first performer data are not limited to video (moving images) and can be still images. The video acquisition unit 153 is configured to supply the acquired first performer data pertaining to video to the performance agent 160. The video acquisition unit 153 can be configured to transmit the acquired first performer data pertaining to video to the estimation device 300.

The performance agent 160 is configured to generate the second performance data indicating the second performance that is performed in parallel with the first performance of the performer and to control the operation of the performance device 200 based on the generated second performance data. The performance agent 160 can be configured to automatically execute the second performance based on the first performer data related to the first performance of the performer. The performance agent 160 can be configured to execute automatic performance control based on any method, such as the method disclosed in International Publication No. 2018/070286, the method disclosed in “Research on real-time score tracking by acoustic signals and active performance assistance system” (Shinji Sakou (Nagoya Institute of Technology), The Telecommunications Advancement Foundation “Research Grant Report” No. 31, 2016), etc. The automatic performance (second performance) can be, for example, an accompaniment to, or a countermelody of, the first performance.

In one example, the performance agent 160 can include an arithmetic model that has a plurality of internal parameters that determine actions (such as “increase the tempo by 1,” “decrease the tempo by 1,” “decrease the tempo by 10,” . . . , “increase the volume by 3,” “increase the volume by 1,” “decrease the volume by 1” and the like) that are executed in accordance with the state at that time (for example, “the difference in volume between the two (performer and performance agent).” “the volume of the performance agent,” “the tempo of the performance agent,” “the time difference between the two,” and the like), for example. The performance agent 160 can be appropriately configured to determine actions in accordance with the state at that time based on the plurality of internal parameters, and change the performance that is performed at that time, in accordance with the determined actions. In the embodiment, the performance agent 160 is configured to include a performance analysis unit 161 and a performance control unit 162 according to the arithmetic model. A non-limiting and a schematic automatic performance control will be illustrated below.

The performance analysis unit 161 is configured to estimate a performance position, which is the position on the musical piece that the performer is currently performing, based on the first performer data pertaining to the first performance supplied from the performance acquisition unit 152 and the video acquisition unit 153. The estimation of the performance position by the performance analysis unit 161 can be executed continuously (for example, periodically) in parallel with the performer's performance.

In one example, the performance analysis unit 161 can be configured to estimate the performance position of the performer by cross-comparing the series of notes indicated by the first performance data and the series of notes indicated by the music data for the automatic performance. The music data include reference part data corresponding to the first performance by the performer (performance part) and automatic part data indicating the second performance (automatic performance part) by the performance agent 160. Any music analysis technique (score alignment technique) can be appropriately employed for the estimation of the performance position by the performance analysis unit 161.

The performance control unit 162 is configured to automatically generate the second performance data indicating the second performance based on the automatic performance data in the music data so as to be synchronized with the progression of the performance position (movement on a time axis) estimated by the performance analysis unit 161, and to supply the generated second performance data to the performance device 200. The performance control unit 162 can thus be configured to cause the performance device 200 to execute an automatic performance corresponding to the automatic part data in the music data, so as to be synchronized with the progress of the performance position (movement on a time axis) estimated by the performance analysis unit 161. More specifically, the performance control unit 162 can be configured to assign an arbitrary expression to a note in the vicinity of the estimated performance position in the musical piece, from among the series of notes indicated by the automatic part data, to generate the second performance data, and to control the performance device 200 to execute an automatic performance in accordance with the generated second performance data. That is, the performance control unit 162 operates as a performance data converter that assigns an arbitrary expression to the automatic part data (for example, time-stamped MIDI data sequences) and supplies it to the performance device 200. The expression assignment here is analogous to human performance expression, and can be, for example, slightly shifting the timing of a note forward or backward, adding an accent to a note, crescendoing or decrescendoing over several notes, etc. The performance control unit 162 can be configured also to supply the second performance data to the estimation device 300. The performance device 200 can be appropriately configured to perform the second performance, which is an automatic performance of a musical piece, in accordance with the second performance data supplied from the performance control unit 162.

The configuration of the performance agent 160 (the performance analysis unit 161 and the performance control unit 162) is not limited to such an example. In another example, the performance agent 160 can be configured to generate the second performance data in an improvised manner based on the first performer data pertaining to the first performance of the performer without using existing music data and supply the generated second performance data to the performance device 200 to cause the performance device 200 to execute the automatic performance (improvised performance).

### (Estimation Device)

The estimation device 300 has a control unit 350 and a storage unit 380. The control unit 350 is configured to integrally control the operation of the estimation device 300 by the CPU 301 and the RAM 302. The storage unit 380 is configured to store various data (specifically, the satisfaction estimation model described further below) used in the control unit 350 by the RAM 302 and the storage 303. The CPU 301 of the estimation device 300 loads the program 83 stored in the storage 303 in the RAM 302 and executes the instructions contained in the program 83 and loaded in the RAM 302. The estimation device 300 (control unit 350) thus operates as a computer that is equipped with software modules implementing an authentication unit 351, a performance acquisition unit 352, a reaction acquisition unit 353, a satisfaction acquisition unit 354, a data preprocessing unit 355, a model training unit 356, a satisfaction estimation unit 357, and a satisfaction output unit 358.

The authentication unit 351 is configured to cooperate with the performance control device 100 to authenticate the user (performer). In one example, the authentication unit 351 determines whether authentication data provided by the performance control device 100 match the authentication data stored in the storage unit 380 and transmits the authentication result (permission or denial) to the performance control device 100.

The performance acquisition unit 352 is configured to acquire (receive) the first performer data of the performer's performance and the second performance data of the performance by the performance device 200 controlled by the performance agent 160. The first performance data and the second performance data are data representing sequences of notes, and can be configured to define the note generation timing, duration, pitch, and intensity of each note. In the embodiment, the first performance data can be performance data of the performer's actual performance or performance data containing features extracted from the performer's actual performance (for example, performance data generated by adding the extracted features to plain performance data). In one example, the performance acquisition unit 352 can be configured to acquire the first performance data that indicate the first performance supplied from the electronic instrument EM, directly from the electronic instrument EM or via the performance control device 100. In another example, the performance acquisition unit 352 can be configured to acquire performance sound representing the first performance using the sound collection unit 306 or via the performance control device 100, and to generate the first performance data based on the data of the acquired performance sound. In yet another example, the performance acquisition unit 352 can be configured to extract features from the performer's actual performance and assign the extracted features to the performance data to which an expression has not been assigned to generate the first performance data. For example, the means disclosed in International Publication No. 2019/022118 can be used as the method for generating the first performance data. In another example, the performance acquisition unit 352 can be configured to acquire the second performance data indicating the second performance generated by the performance agent 160 from the performance control device 100 or the performance device 200. In another example, the performance acquisition unit 352 can be configured to acquire performance sounds representing the second performance using the sound collection unit 306 and to generate the second performance data based on the data of the acquired performance sound. The performance acquisition unit 352 can be configured to associate the acquired first and second performance data with a common time axis and store this data in the storage unit 380. The first performance indicated by the first performance data at a certain time and the second performance indicated by the second performance data at the same time are two performances performed simultaneously (that is, an ensemble). The performance acquisition unit 352 can be configured to associate a user identifier of the performer authenticated by the authentication unit 351 with the above-mentioned first performance data and the second performance data.

The reaction acquisition unit 353 is configured to acquire reaction data indicating one or more reactions of the performer performing the first performance. Here, the one or more reactions of the performer can include at least one or more of the performer's voice, image, or biological data in the collaborative performance. In one example, the reaction acquisition unit 353 can be configured to acquire the reaction data based on video images of the performer captured by the imaging unit 307 that reflect reactions (facial expressions, etc.) of the performer during a collaborative performance. Video of the performer is one example of the performer's image. Further, the reaction acquisition unit 353 can be configured to acquire the reaction data based on the biological information and/or the performance (first performance) that reflect the reactions of the performer. The first performance used to acquire the reaction data can be the first performance data acquired by the performance acquisition unit 352, for example. The biological information used to acquire the reaction data can be formed by one or a plurality of biological signals (for example, heart rate, perspiration volume, blood pressure, etc.) acquired by the biosensor 308 at the time of the first performance of the performer.

The satisfaction acquisition unit 354 is configured to acquire a satisfaction label indicating the personal degree of satisfaction (true value/correct answer) of the performer of a collaborative performance with the performance agent 160 (performance device 200). In one example, the degree of satisfaction indicated by the satisfaction label can be estimated from reaction data acquired by the reaction acquisition unit 353. In one example, the storage unit 380 can hold a correspondence table data indicating the correspondence relationship between the degree of satisfaction and the value indicated by the reaction data, and the satisfaction acquisition unit 354 can be configured to acquire the degree of satisfaction from the performer's reactions indicated by the reaction data based on the correspondence table data. In another example, an emotion estimation model can be used for the estimation of the degree of satisfaction. The emotion estimation model can be appropriately configured to have the ability to estimate the degree of satisfaction from one or more reactions of the performer. The emotion estimation model can be formed by a trained machine learning model generated by machine learning. For example, any machine learning model, such as a neural network, can be employed as the emotion estimation model. Such a trained emotion estimation model can be generated by machine learning using a plurality of training datasets, each formed by a combination of a correct answer label indicating the true value of the degree of satisfaction and reaction data for training indicating the performer's reaction, for example. In this case, the satisfaction acquisition unit 354 can be configured to input the reaction data indicating the performer's reactions into the trained emotion estimation model and to execute a computational processing of the trained emotion estimation model to acquire the result of estimating the degree of satisfaction from the trained emotion estimation model. The trained emotion estimation model can be stored in the storage unit 380. The satisfaction acquisition unit 354 can be configured to associate satisfaction labels with the first and second performance data acquired by the performance acquisition unit 352 to generate datasets and to store each of the generated datasets in the storage unit 380.

The data preprocessing unit 355 is configured to preprocess data (first performance data, second performance data, etc.) that are input to the satisfaction estimation model for estimating the performer's degree of satisfaction, so that the data will be in a form suitable for the computation of the satisfaction estimation model. The data preprocessing unit 355 can be configured to disassemble the first performance data and the second performance data into a plurality of phrases at a common position (time) by an arbitrary method (for example, phrase detection based on chord progression, phrase detection using a neural network, or the like). Further, the data preprocessing unit 355 can be configured to analyze the first performance data and the second performance data pertaining to a collaborative performance to calculate a collaborative performance feature amount. The collaborative performance feature amount is data pertaining to the collaborative performance between the first performance by the performer and the second performance by the performance agent 160 and can be formed by values representing the following features, for example.
Degree of harmony (or discord) between the first performance and the second performance with respect to at least one or more of pitch, volume, or note generation timing
Degree of coincidence or tendency to deviate of note timings at the beginning, middle and end of the corresponding phrases of the first performance and the second performance
Degree of coincidence or tendency to deviate of downbeat positions or upbeat positions of the corresponding phrases of the first performance and the second performance
Degree of coincidence or tendency to deviate of tempo change curves in the corresponding phrases (in particular, the ritardando and accelerando positions) of the first performance and the second performance
Degree of coincidence or tendency to deviate of volume change curves in the corresponding phrases (in particular, the crescendo and decrescendo positions) of the first performance and the second performance
Degree of coincidence or tendency to deviate of change curves (tempo, volume, etc.) in accordance with performance symbols (forte, piano, etc.) in the first performance and the second performance
Degree of following the tempo of the second performance by the performance agent with respect to the tempo of the first performance by the performer
Degree of following the volume of the second performance by the performance agent with respect to the volume of the first performance by the performer
Pitch sequence histogram of the first performance and the second performance when the second performance is an improvised performance or an automatic accompaniment

Regarding the collaborative performance feature amount described above, the “degree of coincidence” pertaining to the timing of notes is the mean and variance of the deviation of the start timings of notes at the beats having the same timing in the first performance and the second performance. The “degree of coincidence” pertaining to change curves is the mean of the degree of similarity (for example, Euclidean distance) for each change type, in the shape of the change curve, which has been classified and normalized into change types (for example, ritardando, accelerando, etc.). The “degree of following” is a value corresponding to the “tracking coefficient” or “coupling coefficient” disclosed in International Publication No. 2018/016637, for example. The “pitch sequence histogram” indicates a frequency distribution obtained by counting the number of notes for each pitch.

In the training stage, the data preprocessing unit 355 is configured to supply the preprocessed data to the model training unit 356. In the estimation stage, the data preprocessing unit 355 is configured to supply the preprocessed data to the satisfaction estimation unit 357.

The model training unit 356 is configured to use the first performance data and the second performance data of each dataset supplied from the data preprocessing unit 355 as the training data (input data) and to use the satisfaction label as the teacher signals (correct answer data), to execute machine learning of the satisfaction estimation model. The training data can be formed by collaborative performance feature amount calculated from the first performance data and the second performance data. In each dataset, the first performance data and the second performance data can be acquired with this data pre-converted into collaborative performance feature amounts. The satisfaction estimation model can be any machine learning model having a plurality of parameters. For example, a feedforward neural network (FFNN) including multilayer perceptrons, a Hidden Markov model (HMM), or the like, can be used as the machine learning model constituting the satisfaction estimation model. In addition, for example, a recurrent neural network (RNN) adapted to time-series data, derivative configurations thereof (long short-term memory (LSTM), gated recurrent unit (GRU), etc.), a convolutional neural network (CNN), or the like, can be used as the machine learning model constituting the satisfaction estimation model.

The machine learning is configured by training the satisfaction estimation model such that, for each of the datasets, a result of estimating the performer's degree of satisfaction from the first performance data and the second performance data using the satisfaction estimation model matches the degree of satisfaction (true value/correct answer) indicated by the satisfaction label. In the embodiment, the machine learning can be configured by training the satisfaction estimation model such that, for each of the datasets, a result of estimating the performer's degree of satisfaction from a collaborative performance feature amount calculated based on the first performance data and the second performance data matches the degree of satisfaction indicated by the satisfaction label. The method of machine learning can be appropriately selected in accordance with the type of machine learning model to be employed. The trained satisfaction estimation model generated by machine learning can be appropriately saved in a storage area of the storage unit 380, or the like, in the form of training result data.

The satisfaction estimation unit 357 includes the trained satisfaction estimation model generated by the model training unit 356. The satisfaction estimation unit 357 is configured to use the trained satisfaction estimation model to estimate the performer's degree of satisfaction from the first performance data and the second performance data acquired at the time of inference. In the embodiment, the estimation can be configured by using the trained satisfaction estimation model to estimate the performer's degree of satisfaction from the collaborative performance feature amount calculated based on the first performance data and the second performance data. In one example, the satisfaction estimation unit 357 inputs the collaborative performance feature amount supplied from the data preprocessing unit 355 to the trained satisfaction estimation model as input data, to execute the computational processing of the trained satisfaction estimation model. By this computational processing, the satisfaction estimation unit 357 acquires an output from the trained satisfaction estimation model that corresponds to the result of estimating the performer's degree of satisfaction from the input collaborative performance feature amount. The estimated degree of satisfaction (estimation result of the degree of satisfaction) is supplied to the satisfaction output unit 358.

The satisfaction output unit 358 is configured to output information related to the result of estimating the degree of satisfaction (estimated degree of satisfaction) by the satisfaction estimation unit 357. The destination and form of the output can be appropriately selected in accordance with the implementation. In one example, outputting information related to the result of estimating the degree of satisfaction can be configured by simply outputting information indicating the estimation result to an output device, such as an output unit 305, for example. In another example, outputting information related to the result of estimating the degree of satisfaction can be configured by executing various control processes based on the result of estimating the degree of satisfaction. Specific examples of control by the satisfaction output unit 358 will be described further below.

### (Other)

In the embodiment, an example in which each software module of the performance control device 100 and the estimation device 300 is realized by a general-purpose CPU is described. However, some or all of the software modules can be realized by one or more dedicated processors. Each of the modules described above can also be realized as a hardware module. Further, with respect to the respective software configuration of the performance control device 100 and the estimation device 300, the software modules can be omitted, replaced, or supplemented as deemed appropriate in accordance with the implementation.

### 4. Operation Example

### (Training Process of Satisfaction Estimation Model)

FIG. 5 is a flowchart showing one example of a training process of the satisfaction estimation model executed by the information processing system S according to the embodiment. The following processing procedure is one example of the trained model establishment method realized by one or a plurality of computers. However, the processing procedure described below is merely an example, and each step thereof can be changed to the extent possible. With respect to the following processing procedure, the steps can be omitted, replaced, or supplemented as deemed appropriate in accordance with the implementation.

In Step S510, the CPU 301 of the estimation device 300 acquires a plurality of datasets, each formed by a combination of first performance data of the first performance of the performer, second performance data of the second performance performed together with the first performance, and a satisfaction label configured to indicate the performer's degree of satisfaction. The CPU 301 can store each of the acquired datasets in the storage unit 380.

In this embodiment, the CPU 301 can operate as the performance acquisition unit 352 and acquire the first performance data of the first performance by the performer and the second performance data of the second performance. In this embodiment, the second performance can be a performance by the performance agent 160 (performance device 200) that performs together with the performer. The CPU 101 of the performance control device 100 can operate as the performance analysis unit 161 and the performance control unit 162 to automatically perform the second performance by the performance agent 160 based on the first performer data pertaining to the first performance of the performer. The CPU 101 can operate as the performance acquisition unit 152 and/or video acquisition unit 153 to acquire the first performer data. The acquired first performer data can be configured to include at least one or more of performance sounds, first performer data, or an image of the first performance by the performer. The image can be acquired as is suitable to show the performer at the time of the first performance. The image can be a moving image (video) or a still image.

Further, the CPU 301 can suitably acquire a satisfaction label. In one example, the CPU 301 can directly acquire the satisfaction label by the performer's input via an input device, such as the input unit 304. In another example, the CPU 301 can acquire the degree of satisfaction from the performer's reactions at the time of the first performance, indicated by the first performance data for training. In this case, the CPU 301 operates as the reaction acquisition unit 353, acquires reaction data indicating the performer's reactions at the time of the first performance, and supplies the acquired reaction data to the satisfaction acquisition unit 354. The CPU 301 can acquire the degree of satisfaction from the reaction data by any method (for example, computation by a prescribed algorithm). The CPU 301 can use the emotion estimation model described above to estimate the degree of satisfaction from the performer's reaction indicated by the reaction data. The satisfaction label can be configured to indicate the estimated degree of satisfaction. The above-mentioned “at the time of the first performance” can include the period of time after the end of the first performance during which the sounds of the performance linger, as well as the time period of the first performance itself. The one or more reactions of the performer can include at least one or more of the voice, image, or biological information of the performer in the collaborative performance.

The order and timing for acquiring the first performance data, the second performance data, and the satisfaction label are not particularly limited and can be determined as deemed appropriate in accordance with the implementation. The number of datasets to be acquired can be determined as deemed appropriate so as to be sufficient for the machine learning of the satisfaction estimation model.

In Step S520, the CPU 301 operates as the data preprocessing unit 355 and preprocesses the first performance data and the second performance data of each dataset supplied from the performance acquisition unit 352. Preprocessing includes calculating the collaborative performance feature amount based on the first performance data and the second performance data of each dataset. The CPU 301 supplies the preprocessed collaborative performance feature amount and the satisfaction label to the model training unit 356. If the first performance data and the second performance data of each dataset obtained in Step S510 are converted into the collaborative performance feature amount in advance, the process of Step S520 can be omitted.

In Step S530, the CPU 301 operates as the model training unit 356 and uses each acquired dataset to execute machine learning of the satisfaction estimation model. In the embodiment, the CPU 301 can train the satisfaction estimation model such that, for each of the datasets, a result of estimating the performer's degree of satisfaction from a collaborative performance feature amount calculated based on the first performance data and the second performance data matches the degree of satisfaction indicated by the satisfaction label. By this machine learning, a trained satisfaction estimation model which has attained the ability to estimate the performer's degree of satisfaction from the first performance data and the second performance data (collaborative performance feature amount) is generated.

In Step S540, the CPU 301 saves the result of the above-described machine learning. In one example, the CPU 301 can generate training result data indicating the trained satisfaction estimation model and store the generated training result data in the storage area of the storage unit 380, or the like. If this machine learning is additional learning or relearning, the CPU 301 can update the training result data stored in the storage area of the storage unit 380, or the like, by the newly generated training result data.

The training process of the satisfaction estimation model according to the operation example is thus concluded. The training process described above can be periodically executed, or executed in accordance with a request from the user (performance control device 100). The CPU 101 of the performance control device 100 and the CPU 301 of the estimation device 300 can each operate as an authentication unit (151, 351) to authenticate the performer before executing the process of Step S510. The dataset of the authenticated performer can be collected to generate the trained satisfaction estimation model.

### (Estimation Process)

FIG. 6 is a flowchart showing one example of an estimation process of the information processing system S according to the embodiment. The following processing procedure is one example of the estimation method realized by one or a plurality of computers. However, the processing procedure described below is merely an example, and each step of the process can be changed to the extent possible. With respect to the following processing procedure, the steps can be omitted, replaced, or supplemented as deemed appropriate in accordance with the implementation.

In Step S610, the CPU 301 of the estimation device 300 operates as the performance acquisition unit 352, acquires the first performance data of the first performance by the performer and the second performance data of the second performance performed together with the first performance, and supplies the acquired first and second performance data to the data preprocessing unit 355. As in the training stage, the second performance in the estimation stage can be a performance by the performance agent 160 (performance device 200) that performs together with the performer.

In Step S620, the CPU 301 operates as the data preprocessing unit 355 and preprocesses the first and second performance data supplied from the performance acquisition unit 352. The preprocessing includes calculating the collaborative performance feature amount based on the acquired first and second performance data. The CPU 301 supplies the preprocessed data (collaborative performance feature amount) to the satisfaction estimation unit 357. The calculation of the collaborative performance feature amount can be performed in advance by another computer. In that case, the process of Step S620 can be omitted.

In Step S630, the CPU 301 operates as the satisfaction estimation unit 357, uses the trained satisfaction estimation model generated by machine learning described above, and estimates the performer's degree of satisfaction from the collaborative performance feature amount calculated based on the acquired first and second performance data. In one example, the CPU 301 inputs the collaborative performance feature amount supplied from the data preprocessing unit 355 to the trained satisfaction estimation model stored in the storage unit 380 to arithmetically process the trained satisfaction estimation model. As a result, the CPU 301 acquires from the trained satisfaction estimation model output corresponding to the result of estimating the performer's personal degree of satisfaction from the input collaborative performance feature amount. The estimated degree of satisfaction is input from the satisfaction estimation unit 357 to the satisfaction output unit 358.

In Step S640, the CPU 301 operates as the satisfaction output unit 358 and outputs information related to the result of estimating the degree of satisfaction. The destination and form of the output can be appropriately selected in accordance with the implementation. In one example, the CPU 301 can output the information indicating the estimation result as is to an output device, such as the output unit 305. In another example, the CPU 301 can execute various control processes based on the result of estimating the degree of satisfaction as the output process. Specific examples of the control process are described in detail in another embodiment.

The estimation process according to this operation example is thus concluded. The processes of Steps S610-S640 described above can be executed in real time in parallel with the first and second performance data being input to the estimation device 30) as the performer takes part in the collaborative performance. Alternatively, the processes of Steps S610-S640 described above can be executed after the fact, i.e., after the collaborative performance has come to an end and with the first and second performance data stored in the estimation device 300, or the like.

### (Features)

By the embodiment, using the training process described above, a trained satisfaction estimation model can be generated that can appropriately estimate the degree of satisfaction of the performer of the first performance with the second performance that is performed together with the first performance by the performer. Further, in the estimation process described above, the trained satisfaction estimation model generated in such a manner can be used to accurately estimate the performer's degree of satisfaction.

Further, by converting the input data (first performance data and the second performance data) to the satisfaction estimation model into the collaborative performance feature amount by the preprocessing of Step S520 and Step S620, the amount of data to be input can be reduced and the satisfaction estimation model can accurately capture the features of the collaborative performance. Thus, it is possible to more accurately estimate the degree of satisfaction and to reduce the computational processing load of the satisfaction estimation model.

Further, in the embodiment, the second performance can be automatically performed by the performance agent 160 based on the first performer data pertaining to the first performance by the performer. Further, the first performer data can include at least one or more of performance sound, performance data, or images of the first performance by the performer. As a result, since the second performance data that match the first performance can be automatically generated by the performance agent 160, the time and effort required to generate the second performance data can be reduced and a trained satisfaction estimation model can be generated that can estimate the performer's degree of satisfaction with the performance agent 160 via the second performance.

Further, in the embodiment, the degree of satisfaction indicated by the satisfaction label can be acquired from the performer's reactions. The emotion estimation model can be used to acquire the degree of satisfaction. It is thus possible to reduce the time and effort required to acquire the plurality of datasets described above. As a result, the cost required for machine learning of the satisfaction estimation model can be reduced.

### 5. Second Embodiment

A second embodiment of this disclosure is described below. In each of the embodiments illustrated below, constituent elements that have the same actions and operations as in the first embodiment have been assigned the same reference numerals as those used in the description above, and their descriptions have been omitted.

The information processing system S according to the first embodiment is configured to generate a trained satisfaction estimation model by machine learning and to use the generated trained satisfaction estimation model to estimate the performer's personal degree of satisfaction with the performance agent 160. In the second embodiment, the information processing system S is configured to estimate the performer's degree of satisfaction with a plurality of performance agents and, based on these degree of satisfaction estimations, to recommend a performance agent suitable for the performer from among the plurality of performance agents.

That is, in the second embodiment, a plurality of performance agents, each having different performance expression characteristics (ability to follow the tempo, volume, etc., of the first performance), i.e., having at least some different internal parameter values, are used. In one example, one performance control device 100 can include a plurality of performance agents 160. In another example, each of a plurality of performance control devices 100 can include one or more performance agents 160. In the following example of the embodiment, for the sake of convenience, it is assumed that a configuration is employed in which one performance control device 100 has a plurality of performance agents 160. Except for these points, the second embodiment can be configured in the same manner as in the first embodiment.

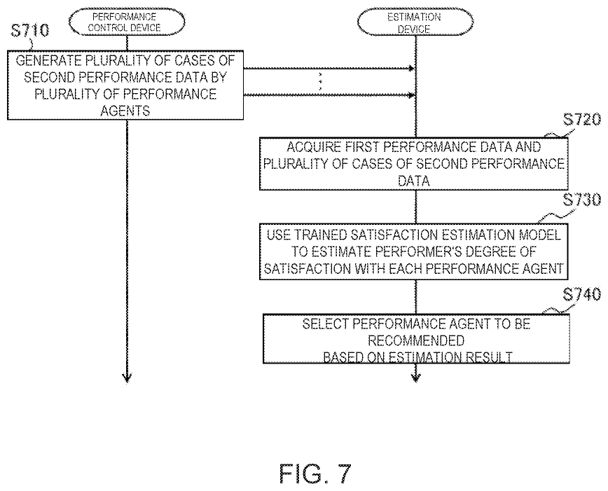

FIG. 7 is a sequence diagram showing an example of a recommendation process of the information processing system S according to the second embodiment. The following process procedure is an example of the performance agent recommendation method realized by one or a plurality of computers. However, the processing procedure described below is merely an example, and each of the steps can be changed to the extent possible. With respect to the following process procedure, the steps can be omitted, replaced, or supplemented as deemed appropriate in accordance with the implementation.

In Step S710, the CPU 101 of the performance control device 100 supplies the first performer data of the first performance by the performer to each of the plurality of performance agents 160 to generate a plurality of pieces of second performance data for a plurality of second performances, respectively corresponding to each of the performance agents 160. More specifically, the CPU 101 operates as the performance analysis unit 161 and the performance control unit 162 of each of the performance agents 160, in the same manner as in the first embodiment, to generate second performance data corresponding to each of the performance agents 160 from the first performer data. The CPU 101 can appropriately supply the second performance data of each of the performance agents 160 to the performance device 200 to cause the performance device 200 to execute the automatic performance (second performance). The second performance data of each of the generated performance agents 160 are supplied to the estimation device 300.

In Step S720, the CPU 301 of the estimation device 300 operates as the performance acquisition unit 352 and acquires the first performance data of the first performance by the performer as well as the plurality of cases (pieces) of the second performance data of the plurality of performance agents 160 generated in Step S710. The first performance data and the second performance data can be acquired in the same manner as in Step S610 of the first embodiment.

In Step S730, the CPU 301 operates as the data preprocessing unit 355 and the satisfaction estimation unit 357 and uses the trained satisfaction estimation model to estimate the performer's degree of satisfaction with the second performance of each of the performance agents 160. The process for estimating the degree of satisfaction with each of the performance agents 160 in Step S720 can be the same as the processes of Steps S620 and S630 in the first embodiment.

In Step S740, the CPU 301 of the estimation device 300 operates as the satisfaction output unit 358 and selects a performance agent to be recommended from among the plurality of performance agents 160 based on the estimated degree of satisfaction for each of the plurality of performance agents 160. In one example, the CPU 301 can select the performance agent 160 with the highest degree of satisfaction or a prescribed number of performance agents 160 in descending order from the highest degree of satisfaction as performance agent(s) to be recommended to the user (performer).

As an example of the output process (control process) of the above-described Step S640, the CPU 301 (or CPU 101) can display on the output unit 305 of the estimation device 300 (or the output unit 105 of the performance control device 100) the recommended performance agent 160 by a message or an avatar that corresponds to the recommended performance agent 160. The user can select the performance agent he or she wishes to perform with based on or in reference to this recommendation.

By the second embodiment, it is possible to use the trained satisfaction estimation model generated by machine learning to estimate the performer's degree of satisfaction with each of the plurality of performance agents 160. Then, by using the results of the degree of satisfaction estimations, it is possible to recommend to the performer the performance agent 160 that is most likely to be compatible with the attributes of the performer.

### 6. Third Embodiment

In the third embodiment, the information processing system S is configured to use the generated trained satisfaction estimation model to estimate the performer's degree of satisfaction with the performance agent 160 and to adjust the internal parameter value(s) of the performance agent 160 so as to improve the performer's degree of satisfaction. Except for these points, the third embodiment can be configured in the same manner as in the first embodiment.

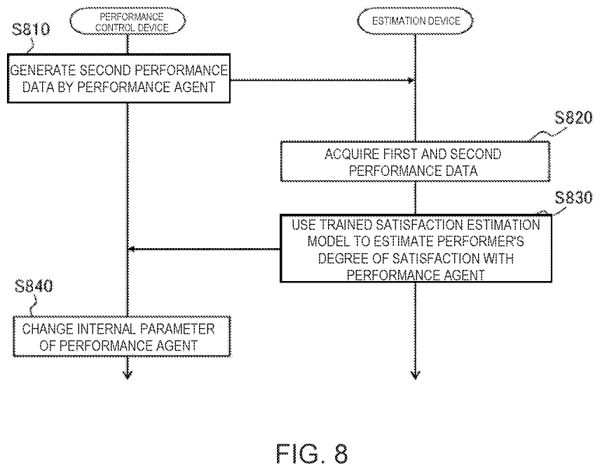

FIG. 8 is a sequence diagram showing an example of an adjustment process of the information processing system S according to the third embodiment. The following process procedure is one example of the performance agent adjustment method realized by one or a plurality of computer. However, the processing procedure described below is merely an example, and each of the steps can be changed to the extent possible. With respect to the following process procedure, the steps can be omitted, replaced, or supplemented as deemed appropriate in accordance with the implementation.

In Step S810, the CPU 101 of the performance control device 100 supplies the first performer data pertaining to the first performance by the performer to the performance agent 160 to generate second performance data of the second performance. The process of Step S810 can be the same as the process for generating the second performance data by each of the performance agents 160 of Step S710 described above. The CPU 101 can supply suitable generated second performance data to the performance device 200 to cause the performance device 200 to execute the automatic performance (second performance). The generated second performance data are supplied to the estimation device 300.

In Step S820, the CPU 301 of the estimation device 300 operates as the performance acquisition unit 352 and acquires the first performance data of the first performance by the performer and the second performance data generated in Step S810. The first performance data and the second performance data can be acquired in the same manner as in Step S610 of the first embodiment.

In Step S830, the CPU 301 operates as the data preprocessing unit 355 and the satisfaction estimation unit 357 and uses the trained satisfaction estimation model to estimate the performer's degree of satisfaction with the second performance of the performance agent 160. The process of estimating the degree of satisfaction with the performance agent 160 in Step S830 can be the same as the processes of Steps S620 and S630 in the first embodiment. As an example of the output process (control process) of the above-described Step S640, the CPU 301 operates as the satisfaction output unit 358 and supplies information indicating the result of the degree of satisfaction estimation to the performance control device 100.

In Step S840, the CPU 101 of the performance control device 100 changes the internal parameter values of the performance agent 160 used when the second performance data are generated. The information processing system S according to the third embodiment iteratively executes the above-described generation (Step S810), estimation (Step S830), and modification (Step S84) to adjust the internal parameter values of the performance agent 160 so as to increase the estimated degree of satisfaction. In one example, in the process of Step S840, which is iteratively executed, the CPU 101 can gradually change the value of each of the plurality of internal parameters of the performance agent 160 in a stochastic manner. Thus, if the degree of satisfaction estimated by the process of Step S830 is higher than the degree of satisfaction estimated in the previous iterative process, the CPU 101 can discard the internal parameter values used in the previous iterative process and employ the internal parameter values of said process. Otherwise, the information processing system S can adjust the internal parameter values of the performance agent 160 so that the estimated degree of satisfaction is higher by repeating the series of processes described above by an arbitrary method (e.g., value iteration method, policy iteration method, etc.).

By the third embodiment, the trained satisfaction estimation model generated by machine learning can be used to estimate the performer's degree of satisfaction with the performance agent 160. Then, by using the result of the degree of satisfaction estimation, the internal parameter values of the performance agent 160 can be adjusted to improve the performer's degree of satisfaction with the second performance by the performance agent 160. As a result, the time and effort required to generate a performance agent 160 compatible with the performer can be reduced.

### 7. Modification

An embodiment of this disclosure has been described above in detail, but the above-mentioned description is merely an example of this disclosure in all respects. Needless to say, various refinements and modifications are possible without deviating from the scope of this disclosure. For example, the following alterations can be made. The following modified examples can be combined as deemed appropriate.

In the embodiment described above, the second performance can be automatically performed by a performance agent 160. However, the second performance need not be limited by this example. In another example, the second performance can be performed by another person besides the performer who performs the first performance (second performer). By the modified example, it is possible to generate a trained satisfaction estimation model that estimates the performer's degree of satisfaction with the second performance by the other actual performer. Further, it is possible to use the generated trained satisfaction estimation model to accurately estimate the performer's degree of satisfaction with the second performance by another actual performer.

Further, in the embodiment described above, the satisfaction estimation model is configured to receive an input of a collaborative performance feature amount calculated based on the first and second performance data. However, the input form of the satisfaction estimation model is not limited to such an example. In another example, first and second performance data that are sequence data can be input to the satisfaction estimation model. In yet another example, sequence data (for example, difference sequences) derived by comparing the first performance and the second performance can be input to the satisfaction estimation model. In these cases, Step S520 and Step S620 can be omitted in each of the processing procedures described above.

In the embodiment described above, the information processing system S is equipped with the performance control device 100, the performance device 200, the estimation device 300, and the electronic instrument EM as separate devices. However, one or more of these devices can be integrally configured. In another example, the performance control device 100 and the performance device 200 can be integrally configured. Or, the performance control device 100 and the estimation device 300 can be integrally configured. When, for example, the performance control device 100 and the estimation device 300 are integrally configured, the CPU 101 and the CPU 301 can be integrally configured as a single processor resource, the storage unit 180 and the storage unit 380 can be integrally configured as a single memory resource, and the program 81 and the program 83 can be stored as a single program.

Further, in the embodiment described above, the estimation device 300 is configured to execute both the training process and the estimation process. However, the training process and the estimation process can be executed by separate computers. In this case, the trained satisfaction estimation model (training result data) can be provided from a first computer that executes the training process to a second computer that executes the estimation process at an arbitrary timing. The number of the first computer and the second computer can be appropriately determined in accordance with the implementation. The second computer can use the trained satisfaction estimation model provided from the first computer to execute the estimation process.

Each of the storage media (91, 93) described above can include a computer-readable non-transitory recording medium. Further, the programs (81, 83) can be supplied via a transmission medium, or the like. In the case that the programs are transmitted via a communication network, such as the Internet, telephone lines, etc., the “computer-readable non-transitory recording medium” can include storage media that retain programs for a set period of time, such as volatile memory (for example, DRAM (Dynamic Random Access Memory)) inside a computer system that constitutes a server, client, etc.

### 8. Additional Statement

A non-transitory computer-readable medium according to one aspect of the present disclosure stores a trained model establishment program that causes a computer to execute a process. The process comprises acquiring a plurality of datasets each of which is formed by a combination of first performance data of a first performance by a performer, second performance data of a second performance performed together with the first performance, and a satisfaction label configured to indicate a degree of satisfaction of the performer, and executing machine learning of a satisfaction estimation model by using the plurality of datasets. The machine learning is configured by training the satisfaction estimation model such that, for each of the datasets, a result of estimating a degree of satisfaction of the performer from the first performance data and the second performance data matches the degree of satisfaction indicated by the satisfaction label.

A non-transitory computer-readable medium according to one aspect of the present disclosure stores an estimation program that causes a computer to execute a process. The process comprises acquiring first performance data of a first performance by a performer and second performance data of a second performance performed together with the first performance, estimating a degree of satisfaction of the performer from the first performance data and the second performance data that have been acquired, by using a trained satisfaction estimation model generated by machine learning, and outputting information pertaining to a result of the estimating the degree of satisfaction.

By this disclosure, it is possible to provide a technology for appropriately estimating the degree of satisfaction of the performer of the first performance with the second performance performed together with the first performance by the performer, a technology for recommending a performance agent that uses said technology, and a technology for adjusting the performance agent.

What is claimed is:

1. A trained model establishment method realized by at least one computer, the trained model establishment method comprising:
acquiring a plurality of datasets each of which is formed by a combination of first performance data of a first performance by a performer, second performance data of a second performance performed together with the first performance, and a satisfaction label configured to indicate a degree of satisfaction of the performer; and
executing machine learning of a satisfaction estimation model, by using the plurality of datasets,
the machine learning being configured by training the satisfaction estimation model such that, for each of the datasets, a result of estimating a degree of satisfaction of the performer from the first performance data and the second performance data matches the degree of satisfaction indicated by the satisfaction label.

2. The trained model establishment method according to claim 1, wherein
the second performance is a performance by a performance agent that performs together with the performer, and
the machine learning is configured by training the satisfaction estimation model such that, for each of the datasets, the result of the estimating the degree of satisfaction of the performer from a collaborative performance feature amount calculated based on the first performance data and the second performance data matches the degree of satisfaction indicated by the satisfaction label.

3. The trained model establishment method according to claim 2, wherein
the second performance is automatically performed by the performance agent based on first performer data pertaining to the first performance of the performer.

4. The trained model establishment method according to claim 3, wherein
the first performer data include at least one or more of a performance sound, the first performance data, or an image for the first performance by the performer.

5. The trained model establishment method according to claim 1, wherein
the satisfaction label is configured to indicate the degree of satisfaction estimated from at least one reaction of the performer by using an emotion estimation model.

6. The trained model establishment method according to claim 5, wherein
the at least one reaction of the performer includes at least one or more of a voice, an image, or biological information for the performer during a collaborative performance with the second performance.

7. The trained model establishment method according to claim 1, wherein
the second performance is a performance by a performance agent that performs together with the performer, and
the second performance is automatically performed by the performance agent based on first performer data pertaining to the first performance of the performer.

8. An estimation method realized by at least one computer, the estimation method comprising:
acquiring first performance data of a first performance by a performer and second performance data of a second performance performed together with the first performance;
estimating a degree of satisfaction of the performer from the first performance data and the second performance data that have been acquired, by using a trained satisfaction estimation model generated by machine learning; and
outputting information pertaining to a result of the estimating the degree of satisfaction.

9. The estimation method according to claim 8, wherein
the second performance is a performance by a performance agent configured to perform together with the performer, and
the estimating includes estimating the degree of satisfaction from a collaborative performance feature amount calculated based on the first performance data and the second performance data, by using the trained satisfaction estimation model.

10. The estimation method according to claim 9, wherein
the second performance is automatically performed by the performance agent based on first performer data pertaining to a first performance by the performer.

11. The estimation method according to claim 10, wherein
the first performer data include at least one or more of a performance sound, the first performance data, or an image for the first performance by the performer.

12. The estimation method according to claim 8, wherein
the first performance data are performance data of an actual performance of the performer, or performance data that include features extracted from the actual performance of the performer.

13. The estimation method according to claim 8, wherein
the second performance is a performance by a performance agent that performs together with the performer, and
the second performance is automatically performed by the performance agent based on first performer data pertaining to the first performance of the performer.

14. A performance agent recommendation method realized by at least one computer, using the estimation method according to claim 8, the performance agent recommendation method comprising:
supplying first performer data pertaining to the first performance to each of a plurality of performance agents that include the performance agent, and generating, at the plurality of performance agents, a plurality of pieces of second performance data for a plurality of second performances that includes the second performance;
estimating the degree of satisfaction of the performer with respect to each of the plurality of performance agents, by using the trained satisfaction estimation model, according to the estimation method; and
selecting one performance agent to be recommended from among the plurality of performance agents based on the degree of satisfaction estimated for each of the plurality of performance agents.

15. An adjustment method realized by at least one computer, using the estimation method according to claim 8, the adjustment method comprising:
supplying first performer data pertaining to the first performance to the performance agent, and generating the second performance data of the second performance at the performance agent;
estimating the degree of satisfaction of the performer with respect to the performance agent, by using the satisfaction estimation model, according to the estimation method; and
modifying an internal parameter value of the performance agent that is used to generate the second performance data,
the generating, the estimating, and the modifying being iteratively executed to adjust the internal parameter value so as to raise the degree of satisfaction.

16. A trained model establishment system comprising:
at least one processor resource; and
at least one memory resource that contains at least one program that is executed by the at least one processor resource,
the at least one processor resource being configured to, by executing the at least one program,
acquire a plurality of datasets each of which is formed by a combination of first performance data of a first performance by a performer, second performance data of a second performance performed together with the first performance, and a satisfaction label configured to indicate a degree of satisfaction of the performer, and
execute machine learning of a satisfaction estimation model, by using the plurality of datasets,
the machine learning being configured by training the satisfaction estimation model such that, for each of the datasets, a result of estimating a degree of satisfaction of the performer from the first performance data and the second performance data matches the degree of satisfaction indicated by the satisfaction label.

17. The trained model establishment system according to claim 16, wherein
the second performance is a performance by a performance agent that performs together with the performer, and
the second performance is automatically performed by the performance agent based on first performer data pertaining to the first performance of the performer.

18. An estimation system comprising:
at least one processor resource; and
at least one memory resource that contains at least one program that is executed by the at least one processor resource,
the at least one processor resource being configured to, by executing the at least one program,
acquire first performance data of a first performance by a performer and second performance data of a second performance performed together with the first performance,
estimate a degree of satisfaction of the performer from the first performance data and the second performance data that have been acquired, by using a trained satisfaction estimation model generated by machine learning, and
output information pertaining to a result of the estimating the degree of satisfaction.

19. The estimation system according to claim 18, wherein
the second performance is a performance by a performance agent that performs together with the performer, and
the second performance is automatically performed by the performance agent based on first performer data pertaining to the first performance of the performer.
